(19) United States
(12) Patent Application Publication
(10) Pub. No.: US 2012/0194626 A1
(43) Pub. Date: Aug. 2, 2012

(54) CASING PRINTING METHOD AND PRINTING APPARATUS USING THE SAME

(76) Inventors: Chung-Yu TSENG, Taipei (TW); Po-Wen Huang, Taipei (TW); Kuei-Fung Tu, Taipei (TW)

(21) Appl. No.: 13/355,260

(22) Filed: Jan. 20, 2012

Related U.S. Application Data
(60) Provisional application No. 61/436,885, filed on Jan. 27, 2011.

(51) Int. Cl. B41J 2/00

(52) U.S. Cl. 347/110

(57) ABSTRACT

A casing printing method and a printing apparatus using the same are disclosed. The printing method includes the following steps: providing an casing material to a printing apparatus, inputting data or information to a receiving module of the printing apparatus, detecting and adjusting a distance between a printing component of a printing module and the surface of the casing material real-timely via the printing module of the printing apparatus, and printing a pattern on the surface of the casing material correspondingly via the printing module of the printing apparatus according to the data or the information. The method can be applied to electronic device casings made of different materials, and it does not need to change the manufacture process and the casing can have diverse patterns or colors.

### CROSS REFERENCE TO RELATED APPLICATIONS

The non-provisional patent application claims priority to U.S. provisional patent application with Ser. No. 61/436,885 filed on Jan. 27, 2011. This and all other extrinsic materials discussed herein are incorporated by reference in their entirety.

### BACKGROUND OF THE INVENTION

1. Field of Invention

The invention relates to a printing method and a printing apparatus using the same and, more particularly, to a casing printing method and a printing apparatus using the same.

2. Related Art

As the material of an object has great influence on the appearance processing, various manufacture processes are developed corresponding to different materials to show specific color or certain visual appearance. For example, plastic can be processed by spraying, texture, embedded molding or in-mold decoration (IMD) (including in-mold film (IMF) and in-mold roller (IMR)); aluminum can be processed by etching, brushing (like hair-line surface treatment) or anodizing; while magnesium alloy is usually processed by baking varnish. However, the corresponding manufacture process may have diverse color or visual appearance ineffectively performed due to its limitations. Moreover, appropriate manufacture processes corresponding to certain materials are not found. When the objects are made of composite material, the appearance processing is more complicated and difficult to control the performance.

### SUMMARY OF THE INVENTION

An electronic device casing printing method and a printing apparatus using the same are disclosed. The method and the printing apparatus can be applied to casings made of different materials. It does not need to change the manufacture process and the appearance of the electronic device can have diverse patterns or colors.

A printing method and a printing apparatus adapted to a stereo model or an electronic device casing which have a large curve surface or a discontinuous surface are disclosed.

An electronic device casing printing method includes following steps: providing a casing material to a printing apparatus, inputting data or information to a receiving module of the printing apparatus, detecting and adjusting a distance between a printing component of a printing module and a surface of the casing material real-time via the printing module, and printing a pattern on the surface of the casing material correspondingly via the printing module.

In an embodiment, the casing material is made of plastic, glass, wood, ceramic, leather, metal, paper or textile.

In an embodiment, the pattern is printed in a non-impact printing way.

In an embodiment, the casing printing method further includes: providing an anti-scratch process to the casing material via an anti-scratch module of the printing apparatus.

A printing apparatus for printing a casing is also disclosed. The printing apparatus includes a receiving module, a processing module and a printing module. The receiving module receives data or information and outputs a control signal. The processing module receives the control signal and outputs a driving signal. The printing module prints a pattern on the casing material correspondingly according to the driving signal. The printing module includes a detecting component, a printing component and a driving component. The detecting component detects a distance between the printing component and the casing material, the driving component adjusts the distance between the printing component and the casing material accordingly.

In an embodiment, the printing module sprays the pattern in a non-impact printing way.

In an embodiment, the printing apparatus further includes: an anti-scratch module to provide an anti-scratch coating on the casing material.

In sum, the casing printing method and the printing apparatus can be used to print patterns on the casing material regardless the material type of the casing. Consequently, the casing printing method and the printing apparatus can be applied to casings made of any material even composite material or combination material. Thus, it does not need to change the manufacture process or adjust settings along with the change of materials or shapes, and the appearance of the electronic device can present more diverse patterns or colors. Furthermore, the printing apparatus can detect and adjust the distance between the printing component and the casing material via the detecting component. As a result, the casing printing method and the printing apparatus can be applied to a stereo model or a casing which have a large curve surface or a discontinuous surface.

These and other features, aspects and advantages of the present invention will become better understood with regard to the following description, appended claims, and accompanying drawings.

### BRIEF DESCRIPTION OF THE DRAWINGS

FIG. 1 is a flow chart showing steps of a casing printing method in a first embodiment;

FIG. 2 is a block diagram showing a printing apparatus in a first embodiment;

FIG. 3 is a schematic diagram showing a printing apparatus in a first embodiment;

FIG. 4 is a block diagram showing a printing apparatus in a second embodiment; and

FIG. 5 is a flow chart showing steps of a casing printing method in a second embodiment.

### DETAILED DESCRIPTION OF THE INVENTION

A casing printing method and a printing apparatus using the same are illustrated with relating figures, and the same symbols denote the same components.

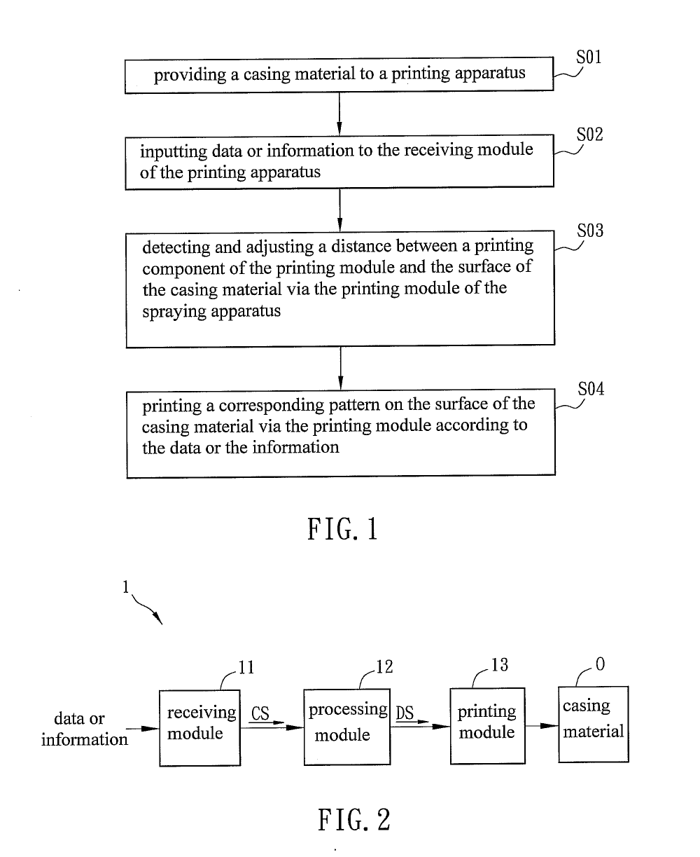

FIG. 1 is a flow chart showing steps of a casing printing method in a first embodiment, and FIG. 2 is a block diagram showing a printing apparatus in a first embodiment.

A printing apparatus 1 includes a receiving module 11, a processing module 12 and a printing module 13.

The casing printing method includes following steps: providing a casing material O to a printing apparatus 1 (S01); inputting data or information to the receiving module 11 of the printing apparatus 1 (S02); detecting and adjusting a distance between a printing component of the printing module 13 and the surface of the casing material O real-time via the printing module 13 of the printing apparatus 1 (S03); and printing a corresponding pattern on the surface of the casing material O via the printing module 13 according to the data or the information (S04). The casing material O may be plastic, glass, wood, ceramic, leather, metal, paper or textile, which is not limited herein.

The receiving module 11 outputs a control signal CS according to the data or the information. The receiving module 11 can receive the data or the information from other devices or apparatuses, and it can also receive the data or the information from a storage medium (such as a memory or an optical disk) which can be read by a computer. The data or the information includes pattern or color information of the casing material O to be processed. The pattern information may include multiple pattern styles, and the color may be black and white, or chromatic. After the processing module 12 receives the control signal CS outputted by the receiving module 11, the processing module 12 outputs a driving signal DS.

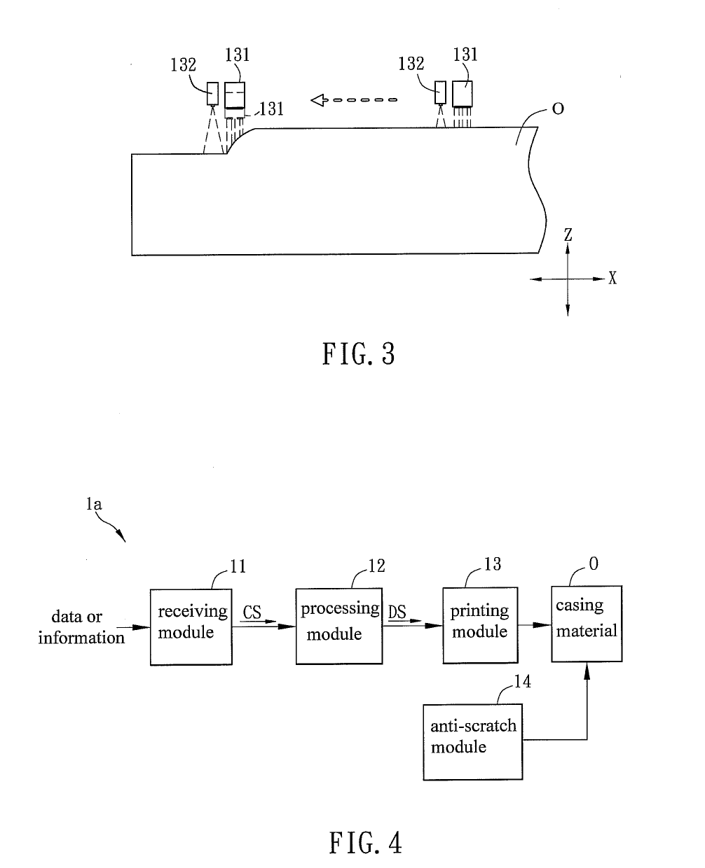

As shown in FIG. 3, the printing module 13 may further include a detecting component 132, a printing component 131 (such as a printing head) and a driving component (not shown). As shown in the right part of FIG. 3, if the surface of the casing material O is a plane surface, a surface with small curves, or a continuous plane, where the distance between the casing material O and the printing component 131 is almost constant. Moreover, as shown in the left part of FIG. 3, if the casing material O is a stereo model, a surface with a large curve, or a discontinuous plane, where the distance between the casing material O and the printing component 131 is not constant. The detecting component 132 can detect the distance changing between the printing component 131 and the casing material O, and the driving component adjusts according to the distance between the printing component 131 and the casing material O.

The printing module 13 sprays the corresponding pattern on the casing material O according to the driving signal DS outputted by the processing module 12. The printing module 13 sprays the pattern or color on the surface of the casing material O by printing. In printing patterns, the detecting component 132 detects the distance between the printing component 131 and the casing material O real-time, and the driving component moves the printing component 131 to an appropriate position to spray patterns. In detail, when the detecting component 132 detects the distance between the printing component 131 and the casing material O changes, the driving component controls the printing component 131 to move, so as to keep the distance between the printing component 131 and the casing material O constant and prevents the sprayed pattern distortion due to the appearance change of the casing material O. The driving component moves the printing component 131 along the direction Z to keep the distance between the printing component 131 and the casing material O constant. Thus, the printing apparatus 1 can spray a stereo model or the casing material O having a large curve or a discontinuous surface.

The printing module 13 may spray the pattern on the casing material O in a non-impact printing way. The ink jet printing can control the position of each ink droplet to make the ink injected to the surface of the casing material O directly by using the deflection of charged ink. Since the ink is injected, the printing module 13 does not need to contact with the casing material O, the printing method has a high speed, high data variability and can be applied to many types of materials. The printing module 13 may be a digital printing apparatus, such as an electronic printing apparatus or an inkjet printing apparatus, which is not limited herein.

As stated above, the casing printing method and the printing apparatus using the same can be applied to a casing of an electronic device, which is not limited herein.

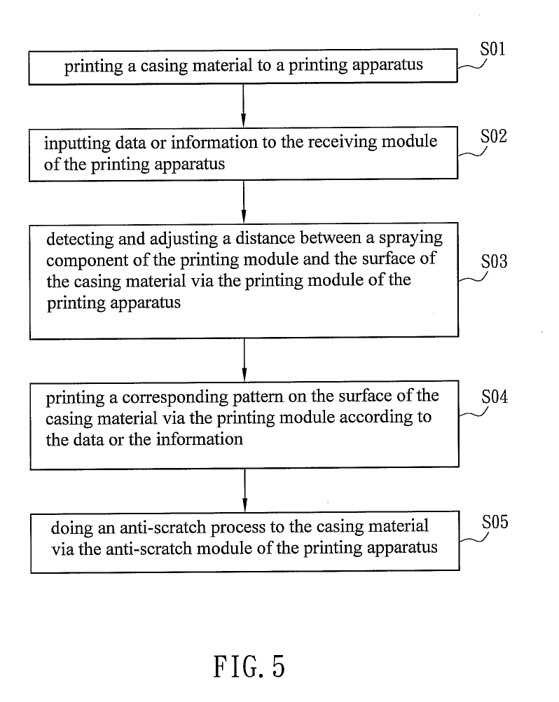

FIG. 4 is a block diagram showing a printing apparatus 1a in a second embodiment, and FIG. 5 is a flow chart showing steps of a casing printing method in a second embodiment.

The difference between the printing apparatus 1a and the printing apparatus 1 is that the printing apparatus 1a further includes an anti-scratch module 14, and the anti-scratch module 14 provides an anti-scratch process on the casing material O that printed with patterns (Step S05). The anti-scratch module 14 provides an anti-scratch coating, such as an ultraviolet (UV) coating, on the casing material O to form a protecting layer on the pattern to avoid scratch.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A casing printing method comprising:
providing a casing material to a printing apparatus;
inputting data or information to a receiving module of the printing apparatus;
detecting and adjusting a distance between a printing component of a printing module and a surface of the casing material real-time via the printing module of the printing apparatus; and
printing a pattern on the surface of the casing material correspondingly via the printing module of the printing apparatus according to the data or the information.

2. The casing printing method according to claim 1, wherein the casing material is made of plastic, glass, wood, ceramic, leather, metal, paper or textile.

3. The casing printing method according to claim 1, wherein the pattern is printed in a non-impact printing way.

4. The casing printing method according to claim 1, wherein the casing printing method further includes:
providing an anti-scratch process to the casing material via an anti-scratch module of the printing apparatus.

5. A printing apparatus for printing a casing, comprising:
a receiving module receiving data or information and outputting a control signal;
a processing module receiving the control signal and outputting a driving signal; and
a printing module printing a pattern on the casing material correspondingly according to the driving signal,
wherein the printing module includes a detecting component, a printing component and a driving component, the detecting component detects a distance between the printing component and the casing material, and the driving component adjusts the distance between the printing component and the casing material accordingly.

6. The printing apparatus according to claim 5, wherein the printing module prints the pattern in a non-impact printing way.

7. The printing apparatus according to claim 5, wherein the printing module is a digital printing apparatus.

8. The printing apparatus according to claim 5, wherein the printing apparatus further includes:
an anti-scratch module to provide an anti-scratch coating on the casing material.
